(19) United States
(12) Patent Application Publication
(10) Pub. No.: US 2009/0114492 A1
(43) Pub. Date: May 7, 2009

(54) Hybrid Vehicle Driveline Noise Damper

(75) Inventors: Michael F. O'Leary, Howell, MI (US); Michael L. Langford, Fenton, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/115,778

(22) Filed: May 6, 2008

Related U.S. Application Data
(60) Provisional application No. 60/985,772, filed on Nov. 6, 2007.

(51) Int. Cl. F16F 7/10

(52) U.S. Cl. 188/378

(57) ABSTRACT

A vehicle driveline includes a hybrid transmission, having a mass damper that provides noise and vibration damping over a broad range of frequencies. The damper provides damping at a desired frequency and all greater frequencies to act as a low pass filter for noise and vibration. A specific mass and inertia for the damper are selected to target the desired frequency range. Due to the hybrid design of the transmission the energy that is used to rotate the damper and provide the desired inertia is recovered by at least one motor/generator within the transmission during deceleration of the vehicle.

### CROSS REFERENCE TO RELATED APPLICATION

This application claims the benefit of U.S. Provisional Patent Application No. 60/985,772 filed Nov. 6, 2007, and which is hereby incorporated by reference in its entirety.

### TECHNICAL FIELD

The present invention relates generally to a noise and vibration damper, and more specifically to a damper for use in a vehicle driveline.

### BACKGROUND OF THE INVENTION

Vehicle drivelines transmit power from a vehicle engine through a transmission and then to the front wheels, rear wheels or all four wheels as desired. Commonly, a driveshaft, or propshaft, is used to transmit torque from an output shaft of the transmission to the rear of the vehicle. The driveshaft would then be connected to an axle, to propagate the torque to the vehicle wheels.

Driveshafts are known to transmit noise and vibration from operation of the engine, transmission, and the driveshaft itself to the axle and from there into the passenger compartment of the vehicle. The noise and vibration are known to peak or amplify at particular rotational frequencies of the driveshafts. The frequencies at which noise and vibration amplify are particular to individual vehicle arrangements.

### SUMMARY OF THE INVENTION

A vehicle driveline having a hybrid transmission, where a mass damper provides noise and vibration damping over a broad range of frequencies is desired.

A vehicle driveline having a hybrid transmission is provided. Due to the hybrid design of the transmission the transmission includes at least one motor/generator. A driveshaft is mounted to an output shaft extending from the transmission. A mass damper is mounted on the driveshaft proximate to the transmission. The damper has a specific mass and inertia to reduce the noise and vibration from further propagation. The mass and inertia of the damper may be based upon a vibration frequency that occurs when the at least one motor/generator has a low torque output.

The above features and advantages, and other features and advantages of the present invention will be readily apparent from the following detailed description of the preferred embodiments and best modes for carrying out the present invention when taken in connection with the accompanying drawings.

### BRIEF DESCRIPTION OF THE DRAWINGS

FIG. 1 is a schematic illustration in side view of an embodiment of a vehicle driveline having a mass damper and a hybrid transmission;

FIG. 2 is a schematic perspective illustration of the driveshaft and damper assembly of FIG. 1;

FIG. 3 is another schematic perspective illustration of the driveshaft and damper assembly of FIG. 1;

FIG. 4 is a graph of revolutions per minute versus time in seconds, illustrating the vehicle conditions of the exemplary vehicle driveline that generate noise and vibration;

FIG. 5 is a graph of revolutions per minute versus time in seconds illustrating the vehicle conditions of the exemplary vehicle driveline of FIG. 4 for a selected time period;

FIG. 6A is a graph illustrating noise in Pascals versus time, measured in the passenger compartment of a vehicle having the vehicle driveline of FIG. 4;

FIG. 6B is a graph illustrating vibration in m/s² versus time, as measured in the transmission and driveshaft of the vehicle driveline of FIG. 4;

FIG. 7A is a graph comparing the level of noise (in Pa dB(A)) measured in the passenger compartment to the frequency of the noise (in Hz) of the vehicle driveline of FIG. 4;

FIG. 7B is a graph comparing the level of vibration (in m/s²) measured to the frequency of the vibration (in Hz) of the vehicle driveline of FIG. 4;

FIG. 8 is a graph of sound pressure level (in dB(A)) versus ⅓ octave bands, illustrating the noise and vibration of damping resulting from the damper assembly of FIGS. 1-3;

FIG. 9 is a graph comparing the level of vibration (in dB) measured to the frequency of the vibration (in Hz) in the transmission and axle (i.e. driveshaft) of the vehicle driveline of FIGS. 1-3;

FIG. 10 is a graph comparing the damping of vibration resulting from the damper assembly of the vehicle driveline of FIG. 9;

FIG. 11 is a schematic illustration in side view of the mass damper for the vehicle driveline of FIGS. 1-3; and

FIG. 12 is a schematic cross-sectional illustration of the mass damper of FIG. 11, taken along line 12-12.

### DESCRIPTION OF THE PREFERRED EMBODIMENTS

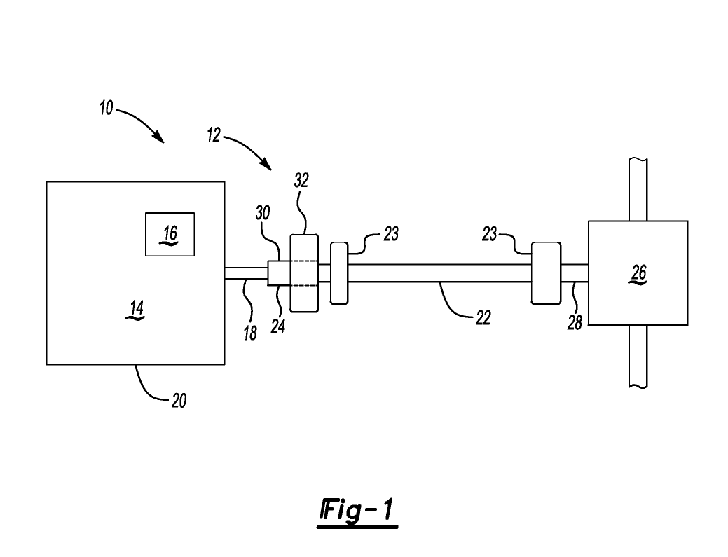

Referring to the Figures, wherein like reference numbers refer to the same or similar components throughout the several views, FIG. 1 is a schematic view of an exemplary vehicle, identified generally as 10, having vehicle driveline 12.

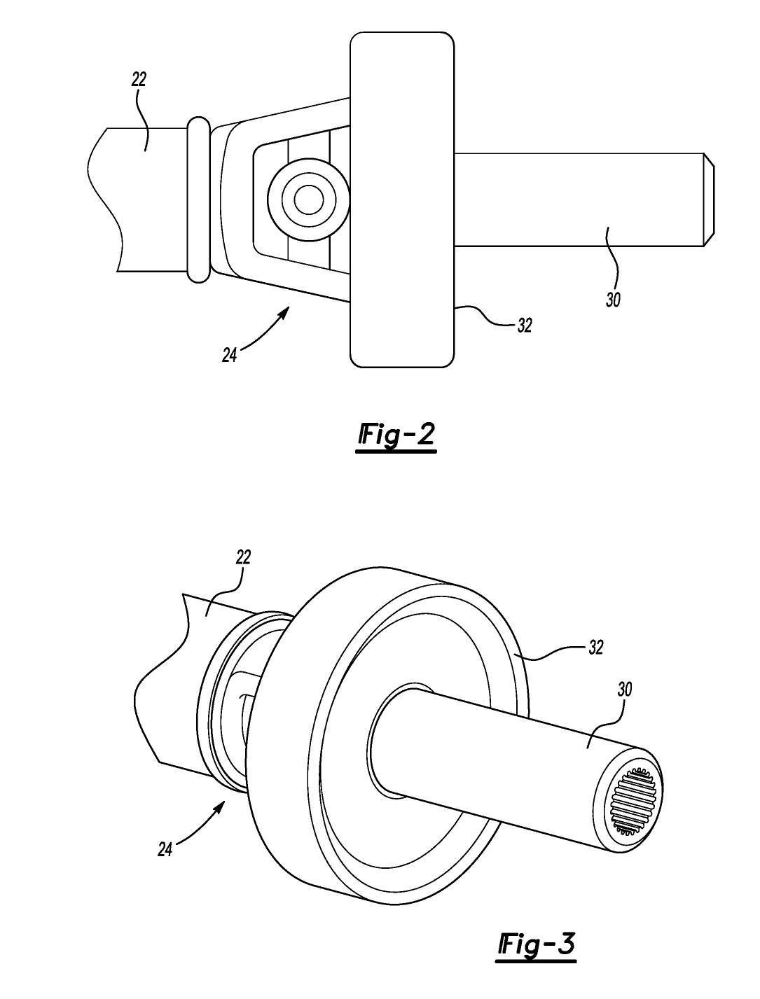

The vehicle driveline 12 includes a transmission 14. The transmission 14 is preferably a hybrid transmission having at least one motor/generator 16 located therein to assist the vehicle engine (not shown) and store power as is known for hybrid transmissions. The transmission 14 includes a transmission output shaft 18 extending from a transmission case 20. A driveshaft 22 is mounted to the output shaft 18 at a first end 24 and to an axle 26 at a second end 28. The driveshaft 22 includes joints 23 to allow for axle 26 travel in the vertical direction relative to the transmission 14. The transmission output shaft 18 is preferably a male shaft as illustrated. The driveshaft 22 includes a female yoke 30 located at the first end 24 for mounting on the male transmission output shaft 18. A damper 32 is mounted to the yoke 30 prior to assembly of the driveshaft 22 with the transmission output shaft 18. FIG. 2 and FIG. 3 illustrate perspective views of the driveshaft 22 with the damper 32 mounted thereon, prior to assembly with the transmission output shaft 18

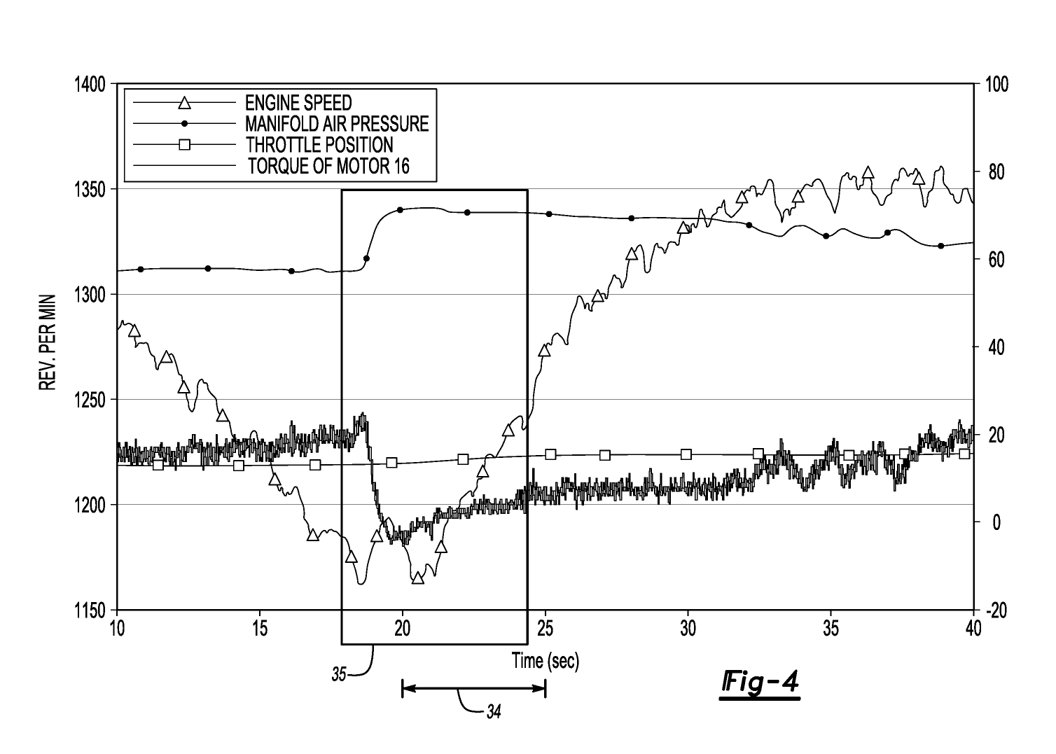

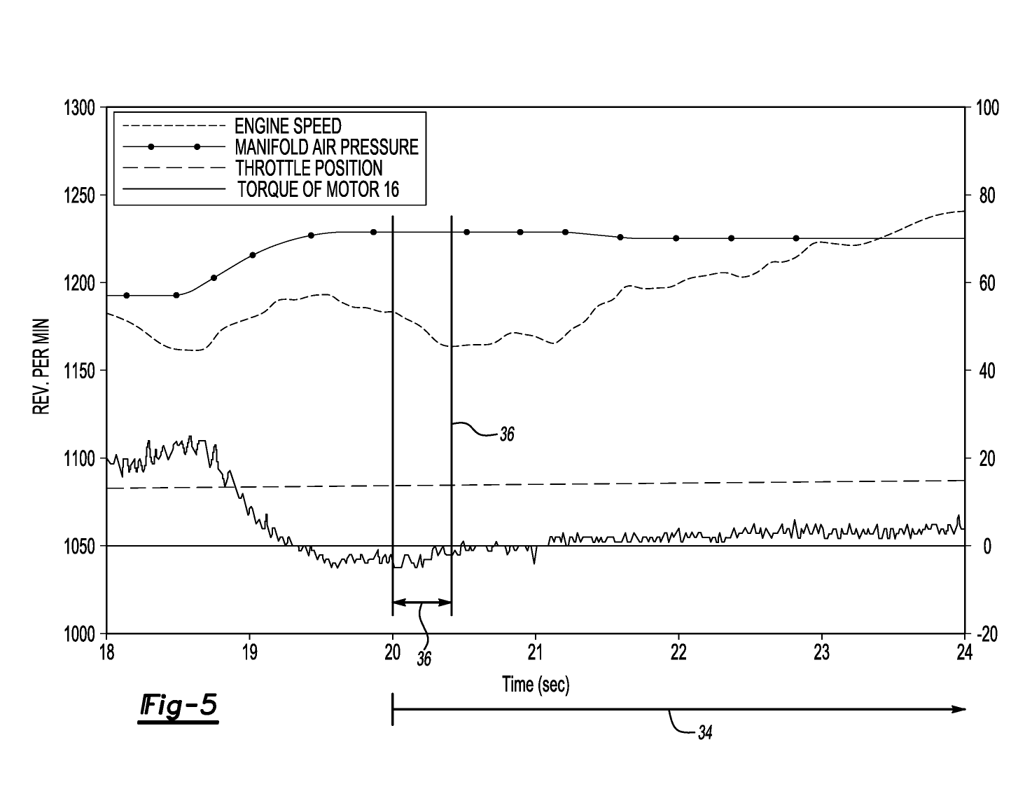

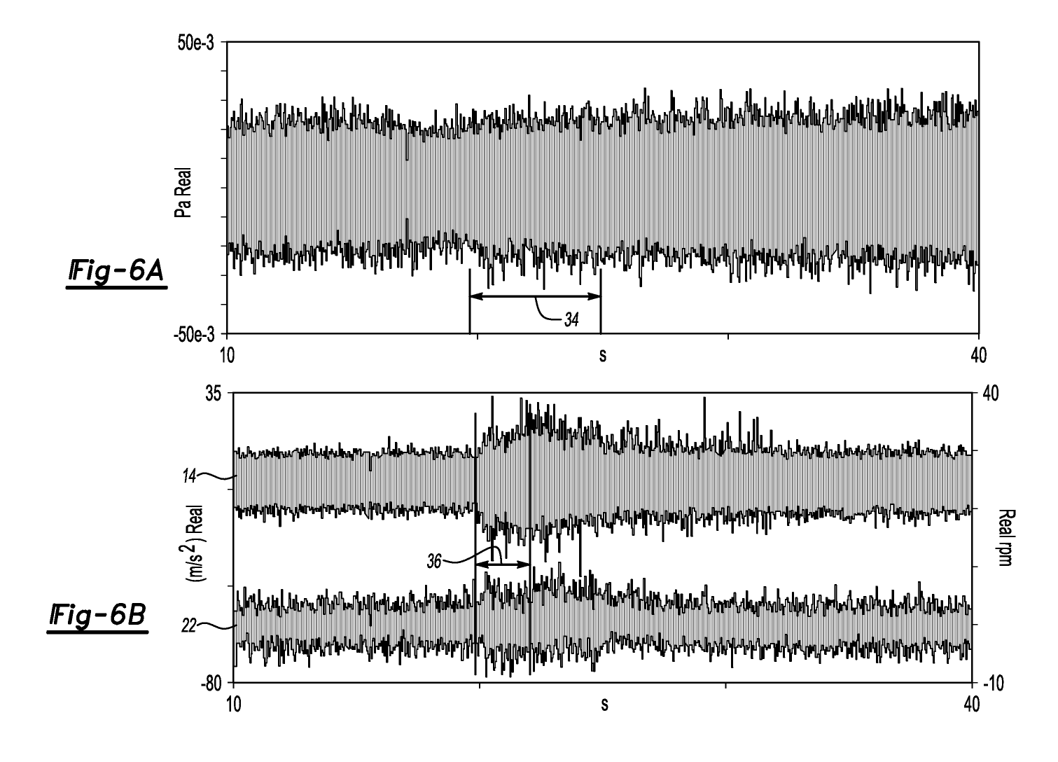

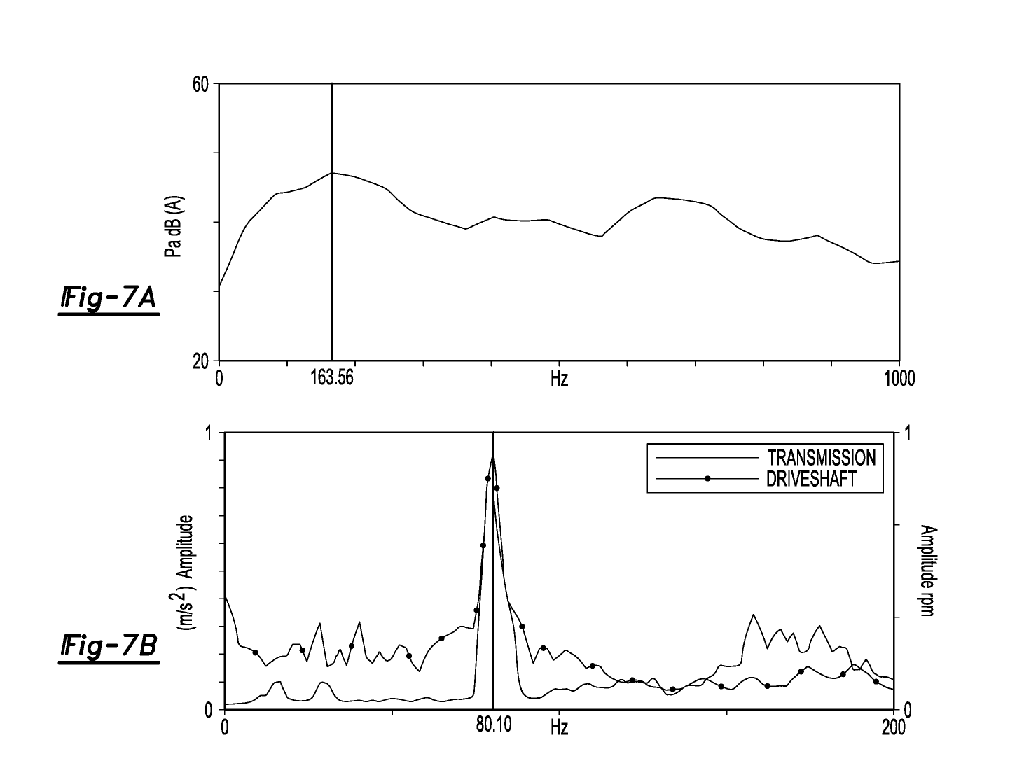

Noise and vibration generated by the vehicle engine (not shown) and the transmission 14 is transferred from the transmission 14 through the output shaft 18. The damper 32 prevents the noise and vibration from further propagating through the driveshaft 22. FIGS. 4-7 illustrate performance parameters of an embodiment of a vehicle driveline experiencing noise and vibration. FIG. 4 illustrates an example of the performance of the vehicle 10 without the damper 32. The engine speed, manifold air pressure and throttle position are displayed to provide a baseline for comparison with the torque of motor/generator 16. Noise and vibration are experienced at unacceptable levels in the marked time range 34. FIG. 5 is a close-up view of the selected time period 35 of FIG. 4. In both FIGS. 4 and 5, the left vertical axis illustrates a scale for engine speed, the right vertical axis illustrates a scale for the manifold air pressure, throttle position and torque of motor/generator 16. FIG. 6A illustrates the level of noise measured in the passenger compartment of the vehicle 10 and FIG. 6B illustrates the level of vibration measured in the transmission 14 and driveshaft 22. FIG. 7A and FIG. 7B illustrate analyzed data from the time segment 36 of FIGS. 5 and 6B. FIG. 7A compares the noise level in the passenger compartment with the frequency of the noise. FIG. 7B compares the vibration of the driveshaft 22 and the motor/generator 16 to the frequency of the vibrations. As can be seen the vibration for both the transmission 14 and the driveshaft 22 increase at the same frequency.

Periodically during operation of the transmission 14 the at least one motor/generator 16 operates at or near zero torque. One situation where this occurs is vehicle launch, or the period of vehicle acceleration immediately subsequent to the vehicle having zero speed. The near zero torque of the at least one motor/generator 16 often results in gear vibration within the transmission 14 and propagation of vibrations from the engine (not shown). Typically, motor/generator 16 torque of up to 10 Nm, in either direction, is low enough to allow noticeable noise and vibration.

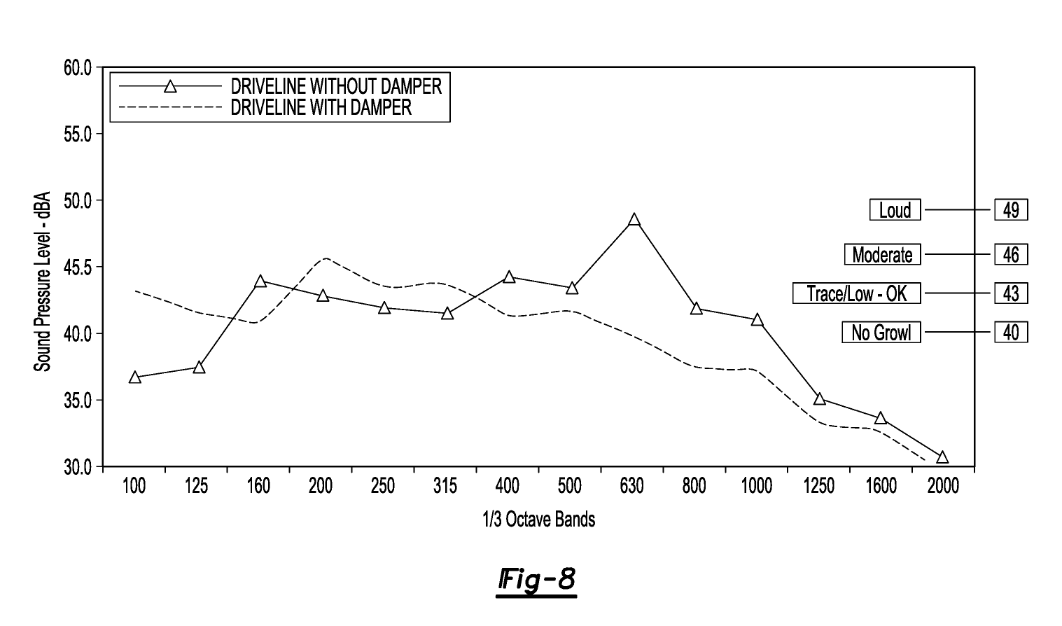

As shown in FIGS. 4-7B the noise and vibrations occur at levels that are unacceptable for passenger comfort. In the example embodiment, the noise and vibration do not reach unacceptable levels until over 400 Hz (FIG. 8). However, over 400 Hz the noise and vibration are at unacceptable levels over a large range of frequencies, from 400 Hz up to approximately 1,000 Hz.

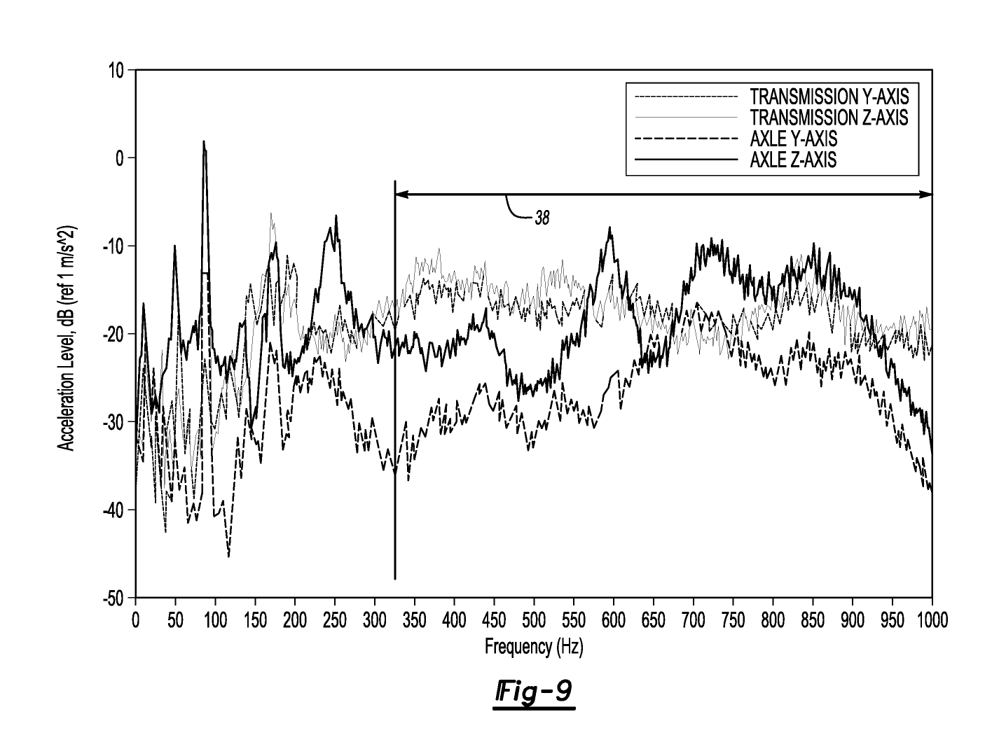

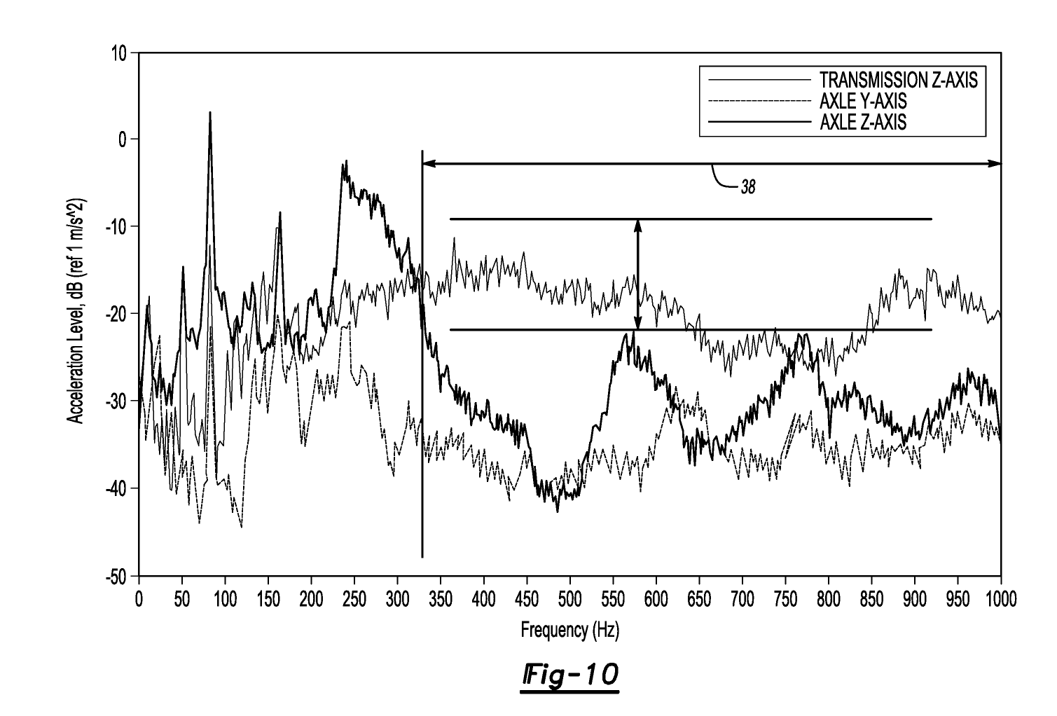

FIGS. 8-10 illustrate the noise and vibration levels of the vehicle driveline 12 having the example damper 32. Frequency range 38 in FIGS. 9 and 10 indicates the frequency range of unacceptable noise and vibration. As used herein, a “low pass filter” is one that allows vibrations below a predetermined frequency to pass while damping or preventing high frequency vibrations from passing through. The damper 32 provides damping at a frequency of approximately 350 Hz and greater. Therefore, the damper 32 acts as a low pass filter for noise and vibration. The low frequency (i.e. less than 350 Hz) noise and vibration will pass through, while the high frequency (i.e. greater than 350 Hz) noise and vibration are damped, thus reducing the noise and vibrations to an acceptable level over a large range of frequencies.

The damper is “tuned” with a mass and inertia. That is, rather than selecting a damper size and spring rate to obtain damping at a specific frequency, a mass and desired inertia are selected. Because the mass does not contain a rubber component there is no need to select a spring rate. In the example shown, the desired inertia ranges from 15,000 to 25,000 kg*mm̂2. The damper 32 is shaped to provide inertia when rotating in the desired range. As mass and inertia of the damper 32 are increased, the effectiveness of the damper 32 is also increased, i.e. the damping capability of the damper is increased. However, adding weight to vehicle components is not desirable. Therefore, for each vehicle application, the desired effectiveness of the damper 32 versus the mass and inertia of the damper 32 must be determined.

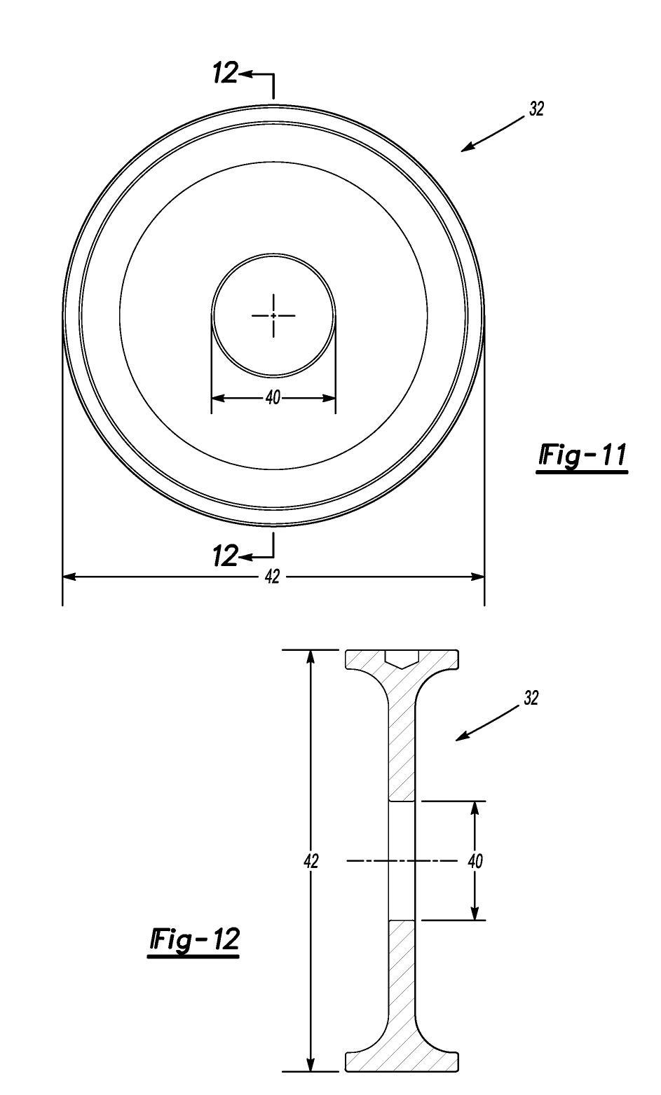

FIG. 11 is a side view of the damper 32 and FIG. 12 shows a cross-section of the damper 32. An inner diameter 40 is selected to provide an interference fit between the damper 32 and the yoke 30 (shown in FIGS. 1-3). An outer diameter 42 of the damper 32 is typically limited by the clearance available in the vehicle needed for other vehicle components. Once the clearance, desired mass and desired inertia are known, an appropriate damper 32 cross-section can be determined to meet the criteria.

The damper 32 may also be mounted to the transmission output shaft 18, rather than the driveshaft 22. The dimensions of the damper 32 would be adjusted to obtain the desired mass and inertia required for dampening while providing for proper fit with the transmission output shaft 18. One skilled in the art would be able to select the size and dimensions required.

Due to the hybrid design of the transmission 14, the energy that is used to rotate the damper 32 and provide the desired inertia can be recovered by controlling (via a controller not shown) the at least one motor/generator 16 to act as a generator during deceleration of the vehicle 10. The inertia is converted to electrical power and stored in an energy storage device, such as a battery.

The above example describes use of the damper 32 for use with a rear wheel-drive hybrid transmission configuration. Other hybrid transmission configurations, such as front wheel-drive or all wheel-drive may benefit as well.

While the best modes for carrying out the invention have been described in detail, those familiar with the art to which this invention relates will recognize various alternative designs and embodiments for practicing the invention within the scope of the appended claims.

1. A vehicle driveline comprising:
a hybrid transmission having at least one motor/generator and an output shaft;
a driveshaft rotatably connected to the output shaft; and
a mass damper mounted to the driveshaft proximate to the transmission, wherein the mass damper is configured to have a predetermined mass and inertia for damping noise and vibration.

2. The vehicle driveline of claim 1, wherein the mass damper further comprises a low pass filter.

3. The vehicle driveline of claim 1, wherein the output shaft is a male component and the driveshaft comprises a female yoke engageable with the output shaft and having the mass damper mounted thereon.

4. The vehicle driveline of claim 1, wherein the predetermined mass and inertia are based upon a vibration frequency that occurs when the at least one motor/generator has an output torque of 10 Nm or less.

5. The vehicle driveline of claim 1, wherein the at least one motor/generator is a generator to recover energy based upon the inertia of the mass damper during deceleration of the vehicle.

6. A vehicle driveline comprising:
a hybrid transmission having at least one motor/generator; and
a mass damper mounted proximate to the transmission, wherein the mass damper is configured to have a predetermined mass and inertia based upon a vibration frequency that occurs when the at least one motor/generator has an output torque of 10 Nm or less for damping noise and vibration.

7. The vehicle driveline of claim 6, wherein the mass damper further comprises a low pass filter.

8. The vehicle driveline of claim 6, wherein the transmission has a male output shaft and further comprising:
a driveshaft having a female yoke rotatably connected to the male output shaft wherein the mass damper is mounted on the driveshaft.

9. The vehicle driveline of claim 6, wherein the at least one motor/generator is a generator to recover energy based upon the inertia of the mass damper during deceleration of the vehicle.

10. A method for damping noise and vibration in a vehicle driveline comprising:
selecting a damper to provide a predetermined mass and inertia;
mounting the damper on a driveshaft; and
connecting the driveshaft to a hybrid transmission output shaft such that the damper is proximate to the transmission such that noise and vibration transmitted from the transmission to the driveshaft during vehicle operation are damped by the damper.

11. The method of claim 10, further comprising selecting the predetermined mass and inertia to suppress the noise and vibration above a predetermined frequency.

12. The method of claim 10, further comprising selecting the predetermined mass and inertia based upon a vibration frequency occurring when the at least one motor/generator has an output torque of 10 Nm or less.

13. The method of claim 10, further comprising:
damping noise and vibration transmitted from the transmission when at least one motor/generator located within the hybrid transmission has a torque output of 10 Nm or less.

14. The method of claim 10, further comprising:
recovering inertia of the damper by controlling the at least one motor/generator to act as a generator during deceleration of the vehicle.
